(19) United States
(12) Patent Application Publication
(10) Pub. No.: US 2015/0364068 A1
(43) Pub. Date: Dec. 17, 2015

(54) Array Substrate and Liquid Crystal Display Panel

(71) Applicant: Shenzhen China Star Optoelectronics Technology Co. Ltd., Shenzhen, Guangdong (CN)

(72) Inventors: Xiaohui YAO, Shenzhen City, Guangdong (CN); Je-hao HSU, Shenzhen City, Guangdong (CN)

(21) Appl. No.: 14/232,278

(22) PCT Filed: Aug. 7, 2013
(86) PCT No.: PCT/CN2013/080981

§ 371 Date: Jan. 12, 2014

(30) Foreign Application Priority Data
Aug. 1, 2013 (CN) 2013103323378

(51) Int. Cl. G09G 3/20; G02F 1/1335; G02F 1/1368; G09G 3/36; G02F 1/1343

(52) U.S. Cl. CPC G09G 3/2003; G09G 3/3607; G09G 3/3648; G09G 3/3674; G02F 1/134309; G02F 1/1368; G02F 1/133514; G09G 2320/0209

(57) ABSTRACT

The present invention discloses an array substrate and a liquid crystal display panel. In the array substrate, each pixel unit comprises a first pixel electrode, a second pixel electrode and a third pixel electrode, which further comprises a control circuit affecting the second pixel electrode. It changes the voltage of the second pixel electrode through the control circuit, and the third pixel electrode is connected with the second pixel electrode through a third switch. In the 2D display mode, the three pixel electrodes are under the state of displaying the image corresponding to the 2D picture. In the 3D display mode, the third pixel electrode is under the state of displaying the image corresponding to the dark picture, and the first pixel electrode and the second pixel electrode are under the state of displaying the image corresponding to the 3D picture. By the above way, the present invention can improve the color distortion in the 2D display mode and 3D, improve the opening ratio in the 2D display mode, and reduce the crosstalk of the two eyes signal in the 3D display mode.

### BACKGROUND OF THE INVENTION

1. Field of the Invention

The present invention relates to the field of display technology, and in particular to an array substrate and a liquid crystal display panel.

2. The Related Arts

VA (Vertical Alignment) liquid crystal display panel has the advantages of fast response, high contrast ratio, etc., which is the mainstream development of the present liquid crystal display panel. However, in the different perspective, the alignment direction of the liquid crystal molecules is different, which also makes the effective refractive index of the liquid crystal molecules different. Therefore, it causes the changes of transmitted light intensity. The concrete manifestation is reduction of transmittance ability in oblique angle. The colors in the directions of the oblique angle and the center angle are different, causing the color difference. Therefore, it can be observed the color distortion in wide angle. In order to improve the color distortion in wide angle, in the pixel design, it divides a pixel to a main pixel region and a sub pixel region. Each pixel region is divided to 4 domains (domain means the small region which the directions of the liquid crystal molecules are substantially the same), and each pixel is divided to 8 domains. By controlling the voltage difference between the main pixel region and the sub pixel region, it makes the arrangements of liquid crystal molecules between two pixel regions different, further improving the color distortion in the wide angle, and achieving the effect of low color shift (LCS).

Moreover, with the development of liquid crystal display technology, most liquid crystal display monitors have compatible features of 2D and 3D display. In the 3D FRR (Film-type Patterned Retarder) stereoscopic display technology, the both adjacent rows pixels respectively correspond to the observer's left eye and right eye, in order to respectively generate the left-eye image corresponding to the left eye and the right-eye image corresponding to the right eye. After the observer's left and right eyes respectively receive the corresponding left-eye image and right-eye image, it makes the observer feel the stereoscopic display effect through the brain combining the left-eye and right-eye images. However, the left-eye and right-eye images are easy to occur crosstalk, which causes the observer to see overlapping images, affecting the viewing experience. In order to avoid the left-eye and right-eye images occurring crosstalk, it adds a light shield region (Black Matrix, BM) between two adjacent rows of pixels to avoid the crosstalk signals, which reduces the eyes signal crosstalk. However, this way will result the reduction of the opening ratio in the 2D display mode and lower the display brightness in the 2D display mode.

In the LCS design described as above, the technical solution, which divides a pixel to a main pixel region and a sub pixel region, can simultaneously solve the opening ratio in the 2D display mode and the two-eye signal crosstalk issue in the 3D display mode, that is, control both the main pixel region and the sub pixel region normally display 2D screen in the 2D display mode. And, make the main pixel region display the dark screen in order to be equivalent to BM in the 3D display mode, which is used to reducing the two-eye signal crosstalk, making the sub pixel region normally display the 3D image. However, in 3D display mode, because the main pixel region displays the dark screen, there is only one sub pixel region normally displaying 3D image in the 3D display mode, which can not achieve the effect of LCS and the color distortion in wide angle can still be observed.

### SUMMARY OF THE INVENTION

The technical issue to be solved by the present invention is to provide an array substrate and a liquid crystal display panel, which can reduce the color distortion in the 2D display mode and 3D with large viewing angle, improve the opening ratio in the 2D display mode, and reduce the crosstalk of the two eyes signal in the 3D display mode.

In order to solve the above issue, a technical solution adopted by the present invention is to provide an array substrate, comprising multiple first scanning lines arranged in rows, multiple second scanning lines arranged in rows, multiple data lines, multiple pixel units arranged in rows and a common electrode used to input common voltage, each pixel unit corresponding to one first scanning line, one second scanning line and one data line; wherein, each pixel unit comprises a first pixel electrode, a second pixel electrode, a third pixel electrode, a first switch, a second switch and a third switch, each pixel unit further comprises a control circuit, the first pixel electrode is connected with the first scanning line and the data line corresponding to the pixel unit through the first switch, the second pixel electrode is connected with the first scanning line and the data line corresponding to the pixel unit through the second switch, the third pixel electrode is connected with the second pixel electrode and the second scanning line corresponding to the pixel unit through the third switch, the control circuit is a fourth switch, the fourth switch comprises a control terminal, a first end and a second end, the control terminal of the fourth switch is connected with the first scanning line corresponding to the pixel unit, the first end of the fourth switch is connected with the second pixel electrode corresponding to the pixel unit, the second end of the fourth switch is connected with the common electrode, the fourth switch is turned on to change the voltage of the second pixel electrode when the first scanning line inputs scanning signal, which controls the voltage difference between the second pixel electrode and the common electrode not to be zero during turning-on time; wherein, in the 2D display mode, the first scanning line inputs scanning signal to control the first switch, the second switch and the fourth scanning, the first pixel electrode and the second pixel electrode receive the data signal from the data line to be under the state of displaying the image corresponding to the 2D picture, the second pixel electrode is electrically connected with the common electrode when the fourth switch is turned on, so that the voltage of the second pixel electrode is changed firstly, and then the first scanning line turns off the first switch and the second switch, the second scanning line inputs scanning signal to turn on the third switch, so that the second pixel electrode is electrically connected with the third pixel electrode, the third pixel electrode receives the data signal from the second pixel electrode to be under the state of displaying the image corresponding to the 2D picture, so that the voltage of the second pixel electrode after first change is changed secondly through the third pixel electrode, the third switch controls the voltage difference between the second pixel electrode and the third pixel electrode not to be zero during turning-on time, wherein, when scanning the first scanning line corresponding to a row of pixel unit, scan the second scanning line corresponding to the previous row of pixel unit which is scanned lately adjacent to the row of pixel unit; wherein, in the 3D display mode, the second scanning line turns off the third switch, the first scanning line inputs scanning signal to turn on the first switch and the second switch, the first pixel electrode and the second pixel electrode receive the data signal from the data line to be under the state of displaying the image corresponding to the 3D picture, the control circuit affects the second pixel electrode to change the voltage of the second pixel electrode, the third pixel electrode is under the state of displaying the image corresponding to the dark picture when the third switch is turned off.

Wherein, the fourth switch is a thin film transistor, the control terminal of the fourth switch is correspondingly the gate of the thin film transistor, the first end of the fourth switch is correspondingly the source of the thin film transistor, the second end of the fourth switch is correspondingly the drain of the thin film transistor, the width to length ratio of the thin film transistor is smaller than a first setting value, so that the voltage difference between the second pixel electrode and the common electrode not to be zero during turning-on time.

Wherein, the array substrate further comprise switch unit and a short circuit line located at the peripheral region of the array substrate; the switch unit comprises multiple controlled switches, the controlled switch comprises a control terminal, an input terminal and an output terminal, the input terminal of each controlled switch is connected with the first scanning line corresponding to a row of pixel unit, the output terminal is connected with the second scanning line corresponding to the previous row of pixel unit adjacent to the row of pixel unit, the control terminals of all the controlled switches are connected with the short circuit line; in the 2D display mode, the short circuit line inputs control signal to turn on all the controlled switches, when the first scanning line corresponding to the row of pixel unit inputs scanning signal, the scanning signal is input to the second scanning line connected with the output terminal of the controlled switch through the controlled switch at the same time, which turns on the third switch; in the 3D display mode, the short circuit line inputs control signal to turn off the controlled switch and the third switch.

Wherein, the area of the third pixel electrode is smaller than that of the first pixel electrode and the second pixel electrode.

Wherein, the third switch is a thin film transistor, the gate of the thin film transistor is connected with the second scanning line, the source of the thin film transistor is connected with the second pixel electrode, the drain of the thin film transistor is connected with the third pixel electrode, the width to length ratio of the thin film transistor is smaller than a second setting value, so that the voltage difference between the second pixel electrode and the third pixel electrode not to be zero during turning-on time.

In order to solve the above issue, another technical solution adopted by the present invention is to provide an array substrate, comprising multiple first scanning lines, multiple second scanning lines, multiple data lines, multiple pixel units and a common electrode used to input common voltage, each pixel unit corresponding to one first scanning line, one second scanning line and one data line; wherein, each pixel unit comprises a first pixel electrode, a second pixel electrode, a third pixel electrode, a first switch, a second switch and a third switch, each pixel unit further comprises a control circuit, the first pixel electrode is connected with the first scanning line and the data line corresponding to the pixel unit through the first switch, the second pixel electrode is connected with the first scanning line and the data line corresponding to the pixel unit through the second, switch, the third pixel electrode is connected with the second pixel electrode and the second scanning line corresponding to the pixel unit through the third switch, the control circuit is connected with the first scanning line and the second pixel electrode corresponding to the pixel unit, the control circuit affects the second pixel electrode to change the voltage of the second pixel electrode when the first scanning line inputs scanning signal, which controls the voltage difference between the second pixel electrode and the common electrode not to be zero; wherein, in the 2D display mode, the first scanning line inputs scanning signal to turn on the first switch and the second switch, the first pixel electrode and the second pixel electrode receive the data signal from the data line to be under the state of displaying the image corresponding to the 2D picture, the control circuit affects the second pixel electrode, so that the voltage of the second pixel electrode is changed firstly, and then the first scanning line turns off the first switch and the second switch, the second scanning line inputs scanning signal to turn on the third switch, so that the second pixel electrode is electrically connected with the third pixel electrode, the third pixel electrode receives the data signal from the second pixel electrode to be under the state of displaying the image corresponding to the 2D picture, so that the voltage of the second pixel electrode after first change is changed secondly through the third pixel electrode, the third switch controls the voltage difference between the second pixel electrode and the third pixel electrode not to be zero during turning-on time; wherein, in the 3D display mode, the second scanning line turns off the third switch, the first scanning line inputs scanning signal to turn on the first switch and the second switch, the first pixel electrode and the second pixel electrode receive the data signal from the data line to be under the state of displaying the image corresponding to the 3D picture, the control circuit affects the second pixel electrode to change the voltage of the second pixel electrode, the third pixel electrode is under the state of displaying the image corresponding to the dark picture when the third switch is turned off.

Wherein, the control circuit is a fourth switch, the fourth switch comprises a control terminal, a first end and a second end, the control terminal of the fourth switch is connected with the first scanning line corresponding to the pixel unit, the first end of the fourth switch is connected with the second pixel electrode corresponding to the pixel unit, the second end of the fourth switch is connected with the common electrode, the fourth switch is turned on when the first scanning line inputs scanning signal, so that the second pixel electrode is electrically connected with the common electrode, and the voltage of the second pixel electrode is changed firstly, the fourth switch controls the voltage difference between the second pixel electrode and the common electrode not to be zero during turning-on time.

Wherein, the fourth switch is a thin film transistor, the control terminal of the fourth switch is correspondingly the gate of the thin film transistor, the first end of the fourth switch is correspondingly the source of the thin film transistor, the second end of the fourth switch is correspondingly the drain of the thin film transistor, the width to length ratio of the thin film transistor is smaller than a first setting value, so that the voltage difference between the second pixel electrode and the common electrode not to be zero during turning-on time

Wherein, the multiple pixel units are arranged in rows, the multiple first scanning lines and the multiple second scanning lines are also arranged in rows; in the 2D display mode, when scanning the first scanning line corresponding to a row of pixel unit, scan the second scanning line corresponding to the previous row of pixel unit which is scanned lately adjacent to the row of pixel unit.

Wherein, the array substrate further comprises a switch unit and a short, circuit line located at the peripheral region of the array substrate; the switch unit comprises multiple controlled switches, the controlled switch comprises a control terminal, an input terminal and an output terminal, the input terminal of each controlled switch is connected with the first scanning line corresponding to a row of pixel unit, the output terminal is connected with the second scanning line corresponding to the previous row of pixel unit adjacent to the row of pixel unit, the control terminals of all the controlled switches are connected with the short circuit line; in the 2D display mode, the short circuit line inputs control signal to turn on all the controlled switches, when the first scanning line corresponding to the row of pixel unit inputs scanning signal, the scanning signal is input to the second scanning line connected with the output terminal of the controlled switch through the controlled switch at the same time, which turns on the third switch; in the 3D display mode, the short circuit line inputs control signal to turn off the controlled switch and the third switch.

Wherein, the area of the third pixel electrode is smaller than that of the first pixel electrode and the second pixel electrode.

Wherein, the third switch is a thin film transistor, the gate of the thin film transistor is connected with the second scanning line, the source of the thin film transistor is connected with the second pixel electrode, the drain of the thin film transistor is connected with the third pixel electrode, the width to length ratio of the thin film transistor is smaller than a second, setting value, so that the voltage difference between the second pixel electrode and the third pixel electrode not to be zero during turning-on time.

In order to solve the above issue, another technical solution adopted by the present invention is to provide a liquid crystal display panel, comprising an array substrate, a color filter substrate and a liquid crystal layer located between the array substrates; wherein, the array substrate comprises multiple first scanning lines, multiple second scanning lines, multiple data lines, multiple pixel units and a common electrode used to input common voltage, each pixel unit corresponding to one first scanning line, one second scanning line and one data line; wherein, each pixel unit comprises a first pixel electrode, a second pixel electrode, a third pixel electrode, a first switch, a second switch and a third switch, each pixel unit further comprises a control circuit, the first pixel electrode is connected with the first scanning line and the data line corresponding to the pixel unit through the first switch, the second pixel electrode is connected with the first scanning line and the data line corresponding to the pixel unit through the second switch, the third pixel electrode is connected with the second pixel electrode and the second scanning line corresponding to the pixel unit through the third switch, the control circuit is connected with the first scanning line and the second pixel electrode corresponding to the pixel unit, the control circuit affects the second pixel electrode to change the voltage of the second pixel electrode when the first scanning line inputs scanning signal, which controls the voltage difference between the second pixel electrode and the common electrode not to be zero; wherein, in the 2D display mode, the first scanning line inputs scanning signal to turn on the first switch and the second switch, the first pixel electrode and the second pixel electrode receive the data signal from the data line to be under the state of displaying the image corresponding to the 2D picture, the control circuit affects the second pixel electrode, so that the voltage of the second pixel electrode is changed firstly, and then the first scanning line turns off the first switch and the second switch, the second scanning line inputs scanning signal to turn on the third switch, so that the second pixel electrode is electrically connected with the third pixel electrode, the third pixel electrode receives the data signal from the second pixel electrode to be under the state of displaying the image corresponding to the 2D picture, so that the voltage of the second pixel electrode after first change is changed secondly through the third pixel electrode, the third switch controls the voltage difference between the second pixel electrode and the third pixel electrode not to be zero during turning-on time; wherein, in the 3D display mode, the second scanning line turns off the third switch, the first scanning line inputs scanning signal to turn on the first switch and the second switch, the first pixel electrode and the second pixel electrode receive the data signal from the data line to be under the state of displaying the image corresponding to the 3D picture, the control circuit affects the second pixel electrode to change the voltage of the second pixel electrode, the third pixel electrode is under the state of displaying the image corresponding to the dark picture when the third switch is turned off.

Wherein, the control circuit is a fourth switch, the fourth switch comprises a control terminal, a first end and a second end, the control terminal of the fourth switch is connected with the first scanning line corresponding to the pixel unit, the first end of the fourth switch is connected with the second pixel electrode corresponding to the pixel unit, the second end of the fourth switch is connected with the common electrode, the fourth switch is turned on when the first scanning line inputs scanning signal, so that the second pixel electrode is electrically connected with the common electrode, and the voltage of the second pixel electrode is changed firstly, the fourth switch controls the voltage difference between the second pixel electrode and the common electrode not to be zero during turning-on time.

Wherein, fourth switch is a thin film transistor, the control terminal of the fourth switch is correspondingly the gate of the thin film transistor, the first end of the fourth switch is correspondingly the source of the thin film transistor, the second end of the fourth switch is correspondingly the drain of the thin film transistor, the width to length ratio of the thin film transistor is smaller than a first setting value, so that the voltage difference between the second pixel electrode and the common electrode not to be zero during turning-on time.

Wherein, the multiple pixel units are arranged in rows, the multiple first scanning lines and the multiple second scanning lines are also arranged in rows; in the 2D display mode, when scanning the first scanning line corresponding to a row of pixel unit, scan the second scanning line corresponding to the previous row of pixel unit which is scanned lately adjacent to the row of pixel unit.

Wherein, the array substrate further comprises a switch unit and a short circuit line located at the peripheral region of the array substrate; the switch unit comprises multiple controlled switches, the controlled switch comprises a control terminal, an input terminal and an output terminal, the input terminal of each controlled switch is connected with the first scanning line corresponding to a row of pixel unit, the output terminal is connected with the second scanning line corresponding to the previous row of pixel unit adjacent to the row of pixel unit, the control terminals of all the controlled switches are connected with the short circuit line; in the 2D display mode, the short circuit line inputs control signal to turn on all the controlled switches, when the first scanning line corresponding to the row of pixel unit inputs scanning signal, the scanning signal is input to the second scanning line connected with the output terminal of the controlled switch through the controlled switch at the same time, which turns on the third switch, in the 3D display mode, the short circuit line inputs control signal to turn off the controlled switch and the third switch.

Wherein, the area of the third pixel electrode is smaller than that of the first pixel electrode and the second pixel electrode.

Wherein, the third switch is a thin film transistor, the gate of the thin film transistor is connected with the second scanning line, the source of the thin film transistor is connected with the second pixel electrode, the drain of the thin film transistor is connected with the third pixel electrode, the width to length ratio of the thin film transistor is smaller than a second setting value, so that the voltage difference between the second pixel electrode and the third pixel electrode not to be zero during turning-on time.

The benefits of the present invention are as follows. Differing from the situation of the prior art, in the array substrate according to the present invention, each pixel unit comprises a first pixel electrode, a second pixel electrode and a third pixel electrode. A control circuit affects the second pixel electrode. The third pixel electrode is connected with the second pixel electrode through a third switch. In the 2D display mode, when the first scanning line inputs scanning signal, the first pixel electrode and the second pixel electrode receive the data signal from the data line to be under the state of displaying the image corresponding to the 2D picture. The control circuit affects the second pixel electrode, so that the voltage of the second pixel electrode is changed firstly. Therefore, the voltages of the first pixel electrode and the second pixel electrode are different, which reduces the color differences under large viewing angle. After the first scanning line stops inputting scanning signal, the third switch is turned on, and the second pixel electrode is electrically connected with the third pixel electrode. The third pixel electrode receives the data signal from the second pixel electrode to be under the state of displaying the image corresponding to the 2D picture, so that the first to the third pixel electrodes are under the state of displaying the image corresponding to the 2D picture in the 2D display mode, which can improve the opening ratio. Moreover, the voltage of the second pixel electrode is changed secondly through the third pixel electrode, so that the voltage difference between the second pixel electrode and the first pixel electrode is increased. And, the third switch controls the voltage difference between the second pixel electrode and the third pixel electrode not to be zero, so that the voltages of the three pixel electrodes are different, which can further reduce the color differences under large viewing angle and reduce color distortion. In the 3D display mode, the first pixel electrode and the second pixel electrode receive the data signal from the data line to be under the state of displaying the image corresponding to the 3D picture. The control circuit affects the second pixel electrode to change the voltage of the second pixel electrode, so that the voltages of the first pixel electrode and the second pixel electrode are different which can reduce the color differences under large viewing angle. Moreover, the second pixel electrode is not connected with the third pixel electrode in the 3D display mode, so that the third pixel electrode cannot receive the data signal from the second pixel electrode. The third pixel electrode is under the state of displaying the image corresponding to the dark picture, which can reduce the crosstalk of the two eyes signal.

### BRIEF DESCRIPTION OF THE DRAWINGS

FIG. 1 is a schematic structure of the array substrate according to an embodiment of the present invention;

FIG. 2 is a schematic structure of a pixel unit shown in FIG. 1;

FIG. 3 is an equivalent circuit of the structure of the four pixel units shown in FIG. 1;

FIG. 4 is a schematic display of the third pixel electrode of the pixel unit shown in FIG. 1 under the 3D display mode;

FIG. 5 is an equivalent circuit of the structure of the pixel unit of the array substrate according to another embodiment of the present invention; and

FIG. 6 is a schematic structure of the liquid crystal display panel according to an embodiment of the present invention.

### DETAILED DESCRIPTION OF THE PREFERRED EMBODIMENTS

The detailed descriptions accompanying drawings and the embodiment of the present invention are as follows.

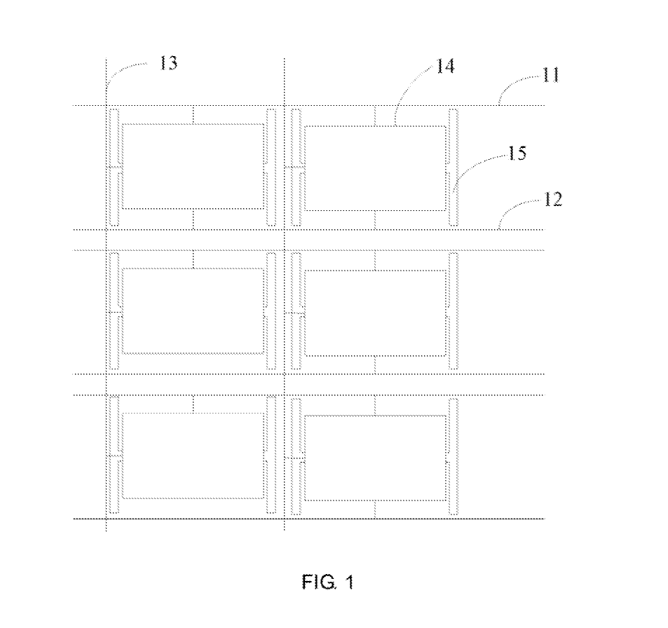

Referring to FIG. 1, in the array substrate according to an embodiment of the present invention, the array substrate comprises multiple first scanning lines 11, multiple second scanning lines 12, multiple data lines 13, multiple pixel units 14 and a common electrode 15 used to input common voltage. The multiple pixel units 14 are arranged in an array. Each pixel unit 14 is connected with one first scanning line 11, one second scanning line 12 and one data line 13.

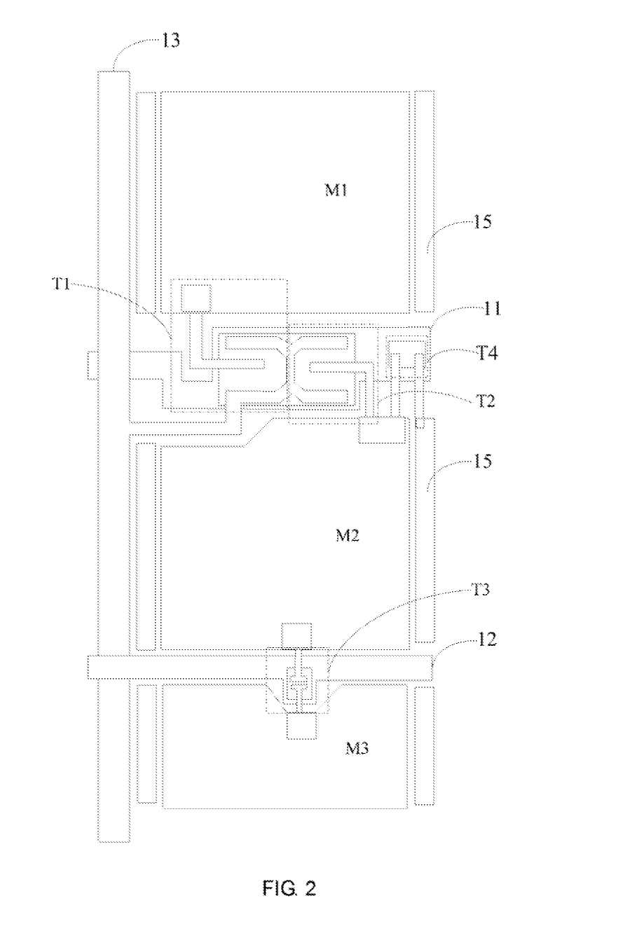

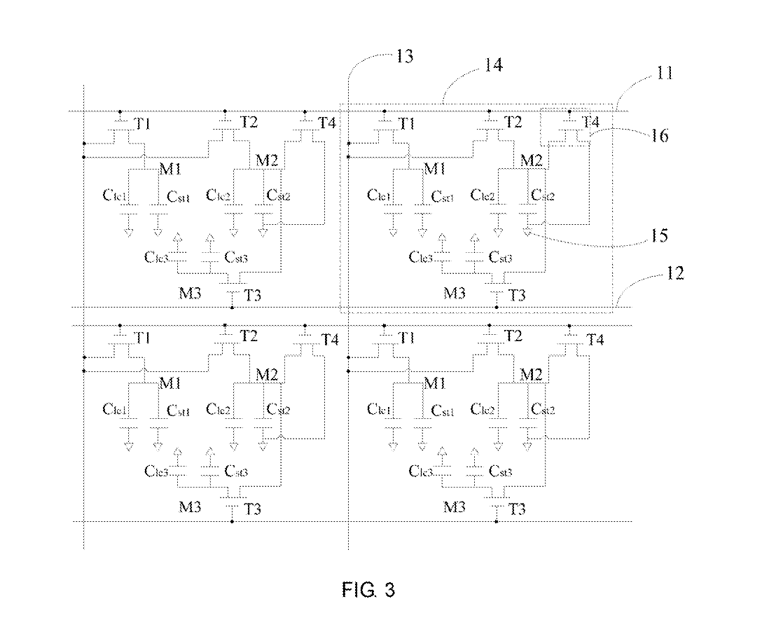

Combining with FIGS. 2 and 3, each pixel unit 14 comprises a first pixel electrode M1, a second pixel electrode M2, a third pixel electrode M3, a first switch T1, a second switch T2 and a third switch T3 respectively affect the first pixel electrode M1, the second pixel electrode M2, the third pixel electrode M3. The control terminal of the first switch T1 and the control terminal of the second switch T2 are electrically connected with the first scanning line 11. The input terminal of the first switch T1 and the input terminal of the second switch T2 are electrically connected with the data line 13. The output terminal of the first switch T1 is electrically connected with the first pixel electrode M1. The output terminal of the second switch T2 is electrically connected with the second pixel electrode M2. The control terminal of the third switch T3 is electrically connected with the second scanning line 12. The input terminal of the third switch T3 is electrically connected with the second pixel electrode M2. The output terminal of the third switch T3 is electrically connected with the third pixel electrode M3.

The first switch T1, the second switch T2 and the third switch T3 according to the present invention are thin film transistor. Wherein, the control terminals of the three switches T1, T2, T3 are correspondingly the gate of the thin film transistor, the input terminals are correspondingly the source of the thin film transistor, the output terminals are correspondingly the drain of the thin film transistor. In the other embodiments, the three switches can also be other switching devices such as triode and Darlington transistor

Each pixel unit 13 further comprises a control circuit 16 The control circuit 16 is connected with the first scanning line 11 and the second pixel electrode M2 corresponding to the pixel unit 14. The control circuit 16 affects the second pixel electrode M2 to change the voltage of the second pixel electrode M2 when the first scanning line 11 inputs scanning signal, which controls the voltage difference between the second pixel electrode M2 and the common electrode 15 not to be zero. Specifically, the control circuit 16 according to the present embodiment is a fourth switch T4. The fourth switch T4 comprises a control terminal, an input terminal and an output terminal. Wherein, the control terminal of the fourth switch T4 is electrically connected with the first scanning line 11. The first end of the fourth switch T4 is electrically connected with the second pixel electrode M2. The second end of the fourth switch T4 is electrically connected with the common electrode 15. Wherein, the fourth switch T4 is a thin film transistor, the control terminal of the fourth switch T4 is correspondingly the gate of the thin film transistor, the first end of the fourth switch T4 is correspondingly the source of the thin film transistor, the second end of the fourth switch T4 is correspondingly the drain of the thin film transistor. The fourth switch T4 is turned on when the first scanning line 11 inputs scanning signal, so that the second pixel electrode M2 is electrically connected with the common electrode 15, the voltage of the second pixel electrode M2 is changed through the common electrode 15, and the fourth switch T4 controls the voltage difference between the second pixel electrode M2 and the common electrode 15 not to be zero during turning-on time, which ensures the second pixel electrode M2 under the state of normally displaying image.

By the array substrate according to the present embodiment, it can reduce the color difference in the 2D display mode and 3D with large viewing angle, improve the opening ratio in the 2D display mode, and reduce the crosstalk of the two eyes signal in the 3D display mode.

Specifically, in the 2D display mode, the present embodiment scans the first scanning line 11 and the second scanning line 12 by row by row scanning mode. The common electrode 15 inputs common voltage. The first scanning line 11 inputs scanning signal with high level to turn on the first switch T1 and the second switch T2. The data line 13 inputs data signal. The first pixel electrode M1 and the second pixel electrode M2 respectively receive the data signal from the data line 13 through the first switch T1 and the second switch T2 and are under the state of displaying the image corresponding to the 2D picture. When the first scanning line 11 inputs the scanning signal with high level, the fourth switch T4 also receives the scanning signal and is turned on. At this time, the second pixel electrode M2 is electrically connected with the common electrode 15. In the positive polarity (ie, the data signal is greater than the common voltage) inversion driving period, the second pixel electrode M2 is discharged through the common electrode 15. The part of the charges are transferred to the common electrode 15, so that the voltage of the second pixel electrode M2 is decreased and no longer the data voltage as receive the data signal, and the voltage difference between the second pixel electrode M2 and the first pixel electrode M1 not to be zero. In the negative polarity (ie, the data signal is smaller than the common voltage) inversion period, the part of the charges of the common electrode 15 are transferred to the second pixel electrode M2, so that the voltage of the second pixel electrode M2 is increased and no longer the data voltage as receive the data signal, and the voltage difference between the second pixel electrode M2 and the first pixel electrode M1 not to be zero. Therefore, whether it is positive polarity reversion or negative polarity reversion, the voltage of the second pixel electrode M2 is changed firstly (increase or decrease) when the fourth switch T4 is turned on.

Moreover, the fourth switch T4 controls the voltage difference between the second pixel electrode M2 and the common electrode 15 not to be zero during turning-on time. Specifically, the turning-on time of the fourth switch T4 is the time of the first scanning line 11 inputting scanning signal. During the positive polarity inversion, through the control of the fourth switch T4, the second pixel electrode M2 only releases the partial charges to the common electrode 15 in the turning-on time of the fourth switch T4, and then the voltage of the second pixel electrode M2 will be decreased, which will not be the same with the voltage of the common electrode 15; during the negative polarity inversion, through the control of the fourth switch T4, the common electrode 15 only releases the partial charges to the second pixel electrode M2 in the turning-on time of the fourth switch T4, and then the voltage of the second pixel electrode M2 will be increased, which will not be the same with the voltage of the common electrode 15. Therefore, there are still a certain voltage difference between the second pixel electrode M2 and the common electrode 15, which ensures the second pixel electrode M2 under the state of normally displaying image. Furthermore, it can control the charge transferring speed between the second pixel electrode M2 and the common electrode 15 by controlling the current passing capacity as the fourth switch T4 is turned on. The current passing capacity means the current amount allowed to flow through as the fourth switch T4 is turned on. For example, reduce the current passing capacity as the fourth switch T4 is turned on, so that the charge transferring speed between the second pixel electrode M2 and the common electrode 15 becomes slower, and then it will not reach discharge equilibrium between them in the turning-on time of the fourth switch T4, which still has a certain voltage difference (i.e. voltage difference is not zero). The fourth switch T4 according to the present embodiment is a thin film transistor. The current amount allowed to flow in the thin film transistor as the fourth switch T4 is turned on relates to the width to length ratio of the thin film transistor. The smaller the width to length ratio is, the less the current is allowed to flow through as the thin film transistor is turned on, and the current passing capacity is smaller. The greater the width to length ratio of the thin film transistor is, the more current is allowed to flow through as the thin film transistor is turned on, and the current passing capacity is greater. Therefore, by controlling the width to length ratio of the thin film transistor, allow the width to length ratio less than a first setting value and the current passing capacity smaller than a certain value as the fourth switch T4 is turned on, so that the fourth switch T4 control the charge transferring speed between the second pixel electrode M2 and the common electrode 15 less than a certain value, which ensures the voltage difference between the second pixel electrode M2 and the common electrode 15 not to be zero in the turning-on time of the fourth switch T4 The first setting value can be chosen according to the actual situation to ensure the voltage difference between the second pixel electrode M2 and the common electrode 15 not to be zero in the turning-on time of the fourth switch T4. Furthermore, when the charger transfer occurs between the second pixel electrode M2 and the common electrode 15 (if the first setting value is too small, it may cause the current allowed to flow through the fourth switch T4 to be zero, and the voltage of the second pixel electrode M2 cannot be changed), the first setting value is allowed to have various option, such as 0.3 or other value.

Of course, in the other embodiments, it can control the current passing capacity as the fourth switch T4 is turned on by controlling the gate voltage amount of the fourth switch. The greater the gate voltage is, the greater the current passing capacity is. On the contrary, it becomes smaller. Moreover, the fourth switch can also be triode, which is not limited.

In the present embodiment, after the first scanning line 11 inputs scanning signal and the data line 13 inputs data signal, the voltage of the second pixel electrode M2 is changed firstly under the affection of fourth switch T4, so that there is a certain voltage between the second pixel electrode M2 and the first pixel electrode M1, which can reduce the color distortion under large viewing angle. Furthermore, the voltage difference between the second pixel electrode M2 and the common electrode 15 is not to be zero in the turning-on time of the fourth switch T4 under the control of the fourth switch T4, which ensures the second pixel electrode M2 under the state of normally displaying image.

After scanning the first scanning line 11, the first scanning line 11 stops inputting scanning signal with high level, so that the first switch T1 and the second switch T2 are turned off, and the second scanning line 12 inputs scanning signal with high level to turn on the third switch T2. At this time, the second pixel electrode M2 is electrically connected with the third pixel electrode M3 through the third switch T3. The third pixel electrode M3 is under the state of displaying the image corresponding to the 2D picture after receiving the data signal from the second pixel electrode M2. Therefore, in the 2D display mode, three pixel electrodes M1, M2, M3 are under the state of displaying the image corresponding to the 2D picture, which can increase the opening ratio of 2D display mode. The voltage of the second pixel electrode M2 is changed secondly through the third pixel electrode M3. That is, after the voltage of the second pixel electrode M2 is changed firstly under the affection of the fourth switch T4, the voltage of the second pixel electrode M2 is changed secondly by charge sharing with the liquid crystal capacitor (the equivalent capacitor resulted from the liquid crystal molecules between the third pixel electrode T3 and the common electrode of the other substrate) as the third switch T3 is turned on. Specifically, in the positive polarity (the data signal is greater than the common voltage) inversion period, the partial charges of the second pixel electrode M2 is transferred to the third pixel electrode M3, then the voltage of the second pixel electrode M2 is decreased again, and the voltage of the third pixel electrode M3 is increased, so that the voltage difference between the second pixel electrode M2 and the first pixel electrode M1 is increased, which further improves the color distortion under large viewing angle. In the negative polarity (the data signal is less than the common voltage) inversion period, because the third pixel electrode M3 still has positive voltage of previous timeframe, the partial charges of the third pixel electrode M3 is transferred to the second pixel electrode M2 as the third switch T3 is turned on, so that the voltage of the second pixel electrode M2 is increased again, and the voltage difference between the second pixel electrode M2 and the first pixel electrode M1 is increased, which further improves the color distortion. Moreover, the third switch T3 controls the voltage difference between the second pixel electrode M2 and the third pixel electrode M3 not to be zero during turning-on time, so that the second pixel electrode M2 and the third pixel electrode M3 will not achieve the discharge equilibrium in the turning-on time of the third switch T3. That is, the voltage of the second pixel electrode Ml is different from that of the third pixel electrode M3, so the voltages of the first pixel electrode M1 the second pixel electrode M2, and the third pixel electrode M3 are different. There is a certain voltage difference within them. Therefore, it can further reduce the color difference in the 2D display mode and 3D with large viewing angle and increase the effect of low color shift.

Furthermore, the third switch T3 according to the present embodiment is a thin film transistor. It can control the width to length ratio of the third switch T3 to control the voltage difference between the second pixel electrode M2 and the third pixel electrode M3 not to be zero during the turning-on time of the third switch T3. That is, it controls the width to length ratio of the third switch T3 to control the current passing capacity of the third switch T3 when turning on. The greater the width to length ratio of the third switch T3 is, the more current is allowed to flow through as the third switch T3 is turned on, and the charge transferring speed between the second pixel electrode M2 and the third pixel electrode M3 is quicker. The smaller the width to length ratio of the third switch T3 is, the less current is allowed to flow through as the third switch T3 is turned on, and the charge transferring speed between the second pixel electrode M2 and the third pixel electrode M3 is slower. In order to ensure the voltage of the second pixel electrode M2 differing from that of the third pixel electrode M3, it can control the charge transferring speed between the second pixel electrode M2 and the third pixel electrode M3 to be slower. Furthermore, make the width to length ratio of the third switch T3 smaller than the second setting value (for example, the second setting value can be 0.2), and then the voltage difference between the second pixel electrode M2 and the third pixel electrode M3 not to be zero in the turning-on time of the third switch T3. In the other embodiment, it can also control the gate voltage of the third switch T3 (the magnitude of the scanning signal input from the second scanning line 12) to control the current passing capacity when the third switch T3 is turned on, which is not limited

After finishing scanning the first scanning line 11 and the second scanning line 12 of a row of pixel unit, scan the first scanning, line 11 and the second scanning line 12 of the next row of pixel unit, and so on.

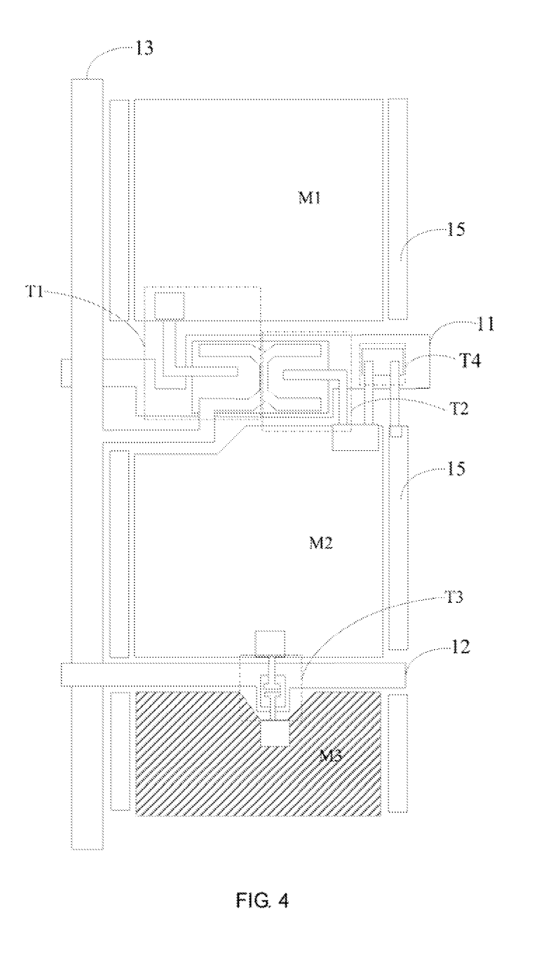

In the 3D display mode, accompanying with FIG. 4, it turns off the third pixel electrode M3 by dark picture signal. That is, the data line 13 inputs the data signal corresponding to the dark picture to turn on the third switch T3, and then the third pixel electrode M3 is under the state of displaying the image corresponding to the dark picture. Wherein, insert black frame in the blanking time of the second scanning line 12 to prevent the leakage light of the second pixel electrode M2 due to electric leakage. After turning off the third pixel electrode M3, the first scanning line 11 inputs a scanning signal with high level to turn on the first switch T1 and the second switch T2. The data line 13 respective inputs the data signal to the first pixel electrode M1 and the second pixel electrode M2 through the first switch and the second switch T3, so that the first pixel electrode M1 and the second pixel electrode M2 are under the state of displaying the image corresponding to the 3D picture. At this time, the fourth switch T4 is also turned on when the first scanning line 11 inputs the scanning signal, so the second pixel electrode M2 is electrically connected with the common electrode 15, and then the voltage of the second pixel electrode M2 is changed That is, the voltage of the second pixel electrode M2 is decreased during the positive polarity reversion, and the voltage of the second pixel electrode M2 is increased during the negative polarity reversion. Therefore, the voltage of the second pixel electrode M2 differs from that of the first pixel electrode M1. There is a certain voltage difference between them, which can improve the color distortion in the 3D display mode. The fourth switch T4 controls the voltage difference between the second pixel electrode M2 and the common electrode 15 not to be zero during turning-on time, which ensures the second pixel electrode M2 under the state of normally displaying image corresponding to 3D picture. Furthermore, in the 3D display mode, turn off the second scanning line 12. That is, do not input the scanning signal to the second scanning line 12, which controls the third switch T3 to be under the state of turning off, so that the third pixel electrode M3 keeps under the state of displaying the image corresponding to the dark picture.

In the present embodiment, the first pixel electrode M1, the second pixel electrode M2, and the third pixel electrode M3 are sequentially arranged in the column direction. Two adjacent rows of the pixel units 14 respectively display the left-eye image and the right-eye image corresponding to the 3D picture. In the 3D display mode, as shown in FIG. 4, the third pixel electrode M3 keeps under the state of displaying the image corresponding to the dark picture through the disconnection of the third switch T3, The third pixel electrode M3 under the state of displaying the image corresponding to the dark picture is a light shielded region, which is equivalent to the black matrix (BM). Therefore, in the adjacent rows of the pixel units 14, there is a light shielded region between the pixel electrode corresponding to the left-eye image (the second pixel electrode and the third pixel electrode in a row of pixel unit) and the pixel electrode corresponding to the right-eye image (the second pixel electrode and the third pixel electrode in the other row of pixel unit). The light shielded region blocks the crosstalk signals of the left-eye image and the right-eye image, which can reduce the crosstalk of the two eyes signal in the 3D display mode. Moreover, the third pixel electrode M3 is mainly used to form light shielded region in the 3D display mode to reduce the crosstalk of the 3D signal. Therefore, the area of the third pixel electrode M3 is smaller than that of the first pixel electrode M1 and the second pixel electrode M2. Of course, it can design the area of the third pixel electrode M3 according to the actually required light shield, which minimizes the crosstalk phenomenon of 3D eyes signals.

Of course, in the alternative embodiment, the three pixel electrodes can also be arranged in the row direction. At this time, the two adjacent rows of the pixel units are respectively under the states of displaying the left-eye image and the right-eye image corresponding to the 3D picture. The third pixel electrode M3 keeps under the state of displaying the image corresponding to the dark picture, which can minimizes the crosstalk of two-eye signals in the 3D display mode. Moreover, in the 3D display mode, it can also utilize the black frame insertion to allow the third pixel electrode under the state of displaying the image corresponding to the dark picture, which inserts black frame in the blanking time of the first scanning line. Furthermore, the first pixel electrode and the second pixel electrode are under the state of displaying the image corresponding to the 3D picture in a scanning frame, and the third pixel electrode is still under the state of displaying the image corresponding to the dark picture. However, in the next scanning frame, the first pixel electrode, the second pixel electrode and the third pixel electrode are under the state of displaying the image corresponding to the dark picture. And then, the first pixel electrode and the second pixel electrode return to the state of displaying the image corresponding to the 3D picture, and the third pixel electrode still keeps under the state of displaying the image corresponding to the 3D picture. That is, the first pixel electrode and the second pixel electrode are alternatively under the state of displaying the image corresponding to the 3D picture and the state of displaying the image corresponding to the dark picture, but the third pixel electrode always keeps under the state of displaying the image corresponding to the 3D picture. By the black frame insertion mentioned above, it can prevent the leakage light of the second pixel electrode due to electric leakage.

By using the array substrate according to the present embodiment, it can improve the opening ratio in the 2D display mode, effectively improve the color distortion in the 2D display mode and 3D, possess better low color shift effect, and reduce the crosstalk of the two-eye signals in the 3D display mode.

In the other embodiments, the control circuit can be replaced by a divider resistor and a switching device. The second pixel electrode is connected with the divider resistor by triggering the switch. When the first scanning line inputs the scanning signal to trigger the switch device to turn on, the voltage of the second pixel electrode is changed through the divider resistor. In this way, it can change the voltage of the second pixel electrode, so that there is a certain voltage difference between the first pixel electrode and the second pixel electrode, which achieves the effect of low color shift.

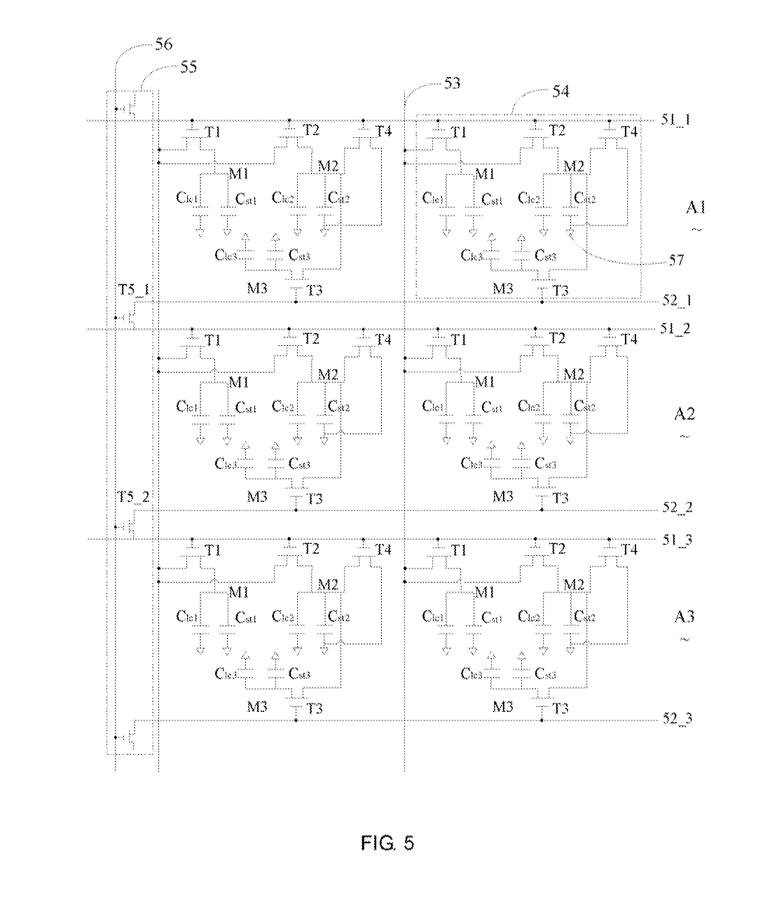

In the above embodiment, in the 2D display mode, it scans the first scanning line and the second scanning line by row by rows canning mode. Referring to FIG. 5, in the array substrate according to another embodiment of the present invention, it can simultaneously scan the first scanning line and the second scanning line corresponding to different pixel units. The first scanning line (only three lines are shown in Figure, including the first scanning line 51_1, 51_2, 51_3) and the second scanning line (only three lines are shown in Figure, including the second scanning line 52_1, 52_2, 52_3) extend along the row direction. In the 2D display mode, take the first row of pixel unit A1 and the second row of pixel unit A2 as example to illustrate, when scanning the first scanning line 51_2 corresponding to the second row of pixel unit A2, scan the second scanning line 52_1 corresponding to the first row of pixel unit A1 which is scanned lately adjacent to the second row of pixel unit A2.

Specifically, the array substrate according to the present embodiment further comprises a switch unit 55 and a short circuit line 56 located at the peripheral region of the array substrate. The switch unit 55 comprises multiple controlled switches (including the controlled switch T5_1, T5_2). The controlled switch comprises a control terminal, an input terminal and an output terminal. Take the controlled switch T5_1 between the first row of pixel unit A1 and the second row of pixel unit A2 as example to illustrate, the input terminal of the controlled switch T5_1 is connected with the first scanning line 51_2 corresponding to the second row of pixel unit A2, the output terminal of the controlled switch T5_1 is connected with the second scanning line 52-1 corresponding to the first row of pixel unit A1, and the control terminals of all the controlled switches are connected with the short circuit line 56. Wherein, the controlled switch T5_1 is a thin film transistor, the control terminal of the controlled switch T5_1 is correspondingly the gate of the thin film transistor, the input terminal of the controlled switch T5_1 is correspondingly the source of the thin film transistor, and the output terminal of the controlled switch T5_1 is correspondingly the drain of the thin film transistor.

In the 2D display mode, the short circuit line 56 inputs control signal with high level to turn on all the controlled switches, and then row by row scan the first scanning line. Firstly, the first scanning line 51_1 corresponding to the first row of pixel unit A1 inputs the scanning signal to turn on the first switch T1 and the second switch T2 in the first row of pixel unit A1. The data line 53 inputs the data signal, so that the first pixel electrode M1 and the second pixel electrode M2 in the first row of pixel unit A1 are under the state of displaying the image corresponding to the 2D picture. The fourth switch T4 is turned on when the first scanning line 51_1 inputs the scanning line, so that the voltage of the second pixel electrode M2 is changed firstly, and the voltages of the first pixel electrode M1 and the second pixel electrode M2 are different. There are a certain voltage difference between them, and the voltage difference between the second pixel electrode M2 and the common electrode 57 not to be zero in the turning-on time of the fourth switch T4, so that the second pixel electrode M2 is under the state of normally displaying image.

After finishing scanning the first scanning line 51_1 corresponding to the first row of pixel unit A1, the first scanning line 51_2 corresponding to the second row of pixel unit A2 inputs the scanning signal to turn on the first switch T1, the second switch T2 and the fourth switch T4 in the second row of pixel unit A2. At this time, the controlled switch T5_1 is turned on, so the scanning signal input from the first scanning line 51_2 is input to the second scanning line 52_1 corresponding to the first row of pixel unit A1 through the controlled switch T5_1, which turns on the third switch T3 in the first row of pixel unit A1 and the second pixel electrode M2 is electrically connected with the third pixel electrode M3 in the first row of pixel unit A1. Therefore, the third pixel electrode M in the first row of pixel unit A1 is under the state of displaying the image corresponding to the 2D picture, which can improve the opening ratio in the 2D display mode. And, the voltage of the second pixel electrode M2 in the first row of pixel unit A1 is changed secondly by charge sharing with the third pixel electrode M3, so that the voltages of the three pixel electrodes M1, M2, M3 in the first row of pixel unit A1 are different. In this way, it can achieve the effect of low color shift. The specific principle can refer to the embodiment described above, which is not repeated here. After finishing scanning the first scanning line 51_2 corresponding to the second row of pixel unit A2, scan the first scanning line 51_3 corresponding to the next row of pixel unit A3, at this time, scan the second scanning line 52_2 corresponding to the second row of pixel unit A2 through the controlled switch T5_2.

In the 3D display mode, the short circuit line 56 inputs control signal to turn off the controlled switch. It inputs the scanning signal to the first scanning line 51_1 to turn on the first switch T1 and the second switch T2 in the first row of pixel unit A1. The data line 53 inputs the data signal, so that the first pixel electrode M1 and the second pixel electrode M2 in the first row of pixel unit A1 are under the state of displaying the image corresponding to the 3D picture. The fourth switch T4 is turned on when the first scanning line 51_1 inputs the scanning line, so that the voltage of the second pixel electrode M2 is changed firstly, and the voltages of the first pixel electrode M1 and the second pixel electrode M2 are different. There are a certain voltage difference between them, and the voltage difference between the second pixel electrode M2 and the common electrode 57 not to be zero in the turning-on time of the fourth switch T4, so that the second pixel electrode M2 is under the state of normally displaying image.

After finishing scanning the first scanning line 51_1 corresponding to the first row of pixel unit A1, input the scanning signal to the first scanning line 51_2 corresponding to the second row of pixel unit A2 to turn on the first switch T1, the second switch T2 and the fourth switch T4 in the second row of pixel unit A2. The controlled switch T5_1 is turned off, so the scanning signal input from the first scanning line 51_2 in the second row of pixel unit A2 will not input to the third switch T3 corresponding to the first row of pixel unit A1, which turns off the third switch T3, and the third pixel electrode M3 in the first row of pixel unit A1 keeps under the state of displaying the image corresponding to the dark picture. The third pixel electrode M3 keeping under the state of displaying the image corresponding to the dark picture can reduce the crosstalk of the two-eye signals in the 3D display mode. After finishing scanning the first scanning line 51_2 corresponding to the second row of pixel unit A2, sequentially scan the remaining first scanning line. In the 3D display mode, all the controlled switches in the switch unit 55 are always turned off.

Through the switch unit 55 and the short circuit 56 according to the present embodiment, it only need one scanning driver chip to apply control signal to the short circuit 56 to turn on or turn off the controlled switch of the switch unit 55, so that the third switch T3 is correspondingly turned on or turned off. It can achieve not only low color shift and higher opening ratio in the 2D display mode, but also low color shift and low crosstalk in the 3D display mode. At the same time, it can reduce the amount of the scanning driver chip and reduce the costs. Moreover, it scans two scanning lines (such as the second scanning line 52_1 corresponding to the first row of pixel unit A1 and the first scanning line 51_2 corresponding to the second row of pixel unit A2) in a scanning frame at the same time, which correspondingly extends the scanning time of each scanning line and contributes to the operation in high refresh rate.

Moreover, in the other embodiments, it can also not use the switch unit 55 and the short circuit 56 mentioned above to scan the first scanning line and the second scanning line corresponding to different rows of pixel unit at the same time. Instead, each scanning lines (including the first scanning line and the second scanning line) are independent to each other. Each scanning line is connected with a scanning driver chip, which individually controls one scanning line to scan. Therefore, when inputting the scanning signal to the first scanning line corresponding to a row of pixel unit, input the scanning signal to the second scanning line corresponding to the previous row of pixel unit. In this way, it can also scan two scanning line at the same time.

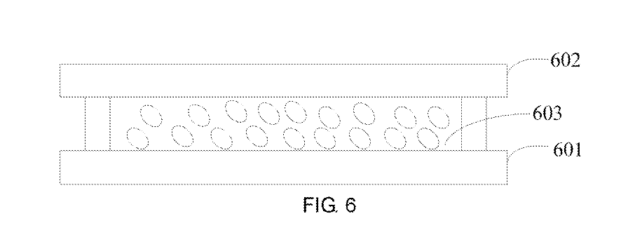

Referring to FIG. 6, in the liquid crystal display panel according to an embodiment of the present invention, the liquid crystal display panel comprises an array substrate 601, a color filter substrate 602 and a liquid crystal layer 603 located between the array substrate 601 and the color filter substrate 602. Wherein, the array substrate 601 is the array substrate mentioned in the above embodiments.

The preferred embodiments according to the present invention are mentioned above, which cannot be used to define the scope of the right of the present invention. Those modifications and variations are considered encompassed in the scope of protection defined by the clams of the present invention.

What is claimed is:

1. An array substrate, comprising multiple first scanning lines arranged in rows, multiple second scanning lines arranged in rows, multiple data lines, multiple pixel units arranged in rows and a common electrode used to input common voltage, each pixel unit corresponding to one first scanning line, one second scanning line and one data line;
wherein, each pixel unit comprises a first pixel electrode, a second pixel electrode, a third pixel electrode, a first switch, a second, switch and a third switch, each pixel unit further comprises a control circuit, the first pixel electrode is connected with the first scanning line and the data line corresponding to the pixel unit through the first switch, the second pixel electrode is connected with the first scanning line and the data line corresponding to the pixel unit through the second switch, the third pixel electrode is connected with the second pixel electrode and the second scanning line corresponding to the pixel unit through the third switch, the control circuit is a fourth switch, the fourth switch comprises a control terminal, a first end and a second end, the control terminal of the fourth switch is connected with the first scanning line corresponding to the pixel unit, the first end of the fourth switch is connected with the second pixel electrode corresponding to the pixel unit, the second end of the fourth switch is connected with the common electrode, the fourth switch is turned on to change the voltage of the second pixel electrode when the first scanning line inputs scanning signal, which controls the voltage difference between the second pixel electrode and the common electrode not to be zero during turning-on time;
wherein, in the 2D display mode, the first scanning line inputs scanning signal to control the first switch, the second switch and the fourth scanning, the first pixel electrode and the second pixel electrode receive the data signal from the data line to be under the state of displaying the image corresponding to the 2D picture, the second pixel electrode is electrically connected with the common electrode when the fourth switch is turned on, so that the voltage of the second pixel electrode is changed firstly, and then the first scanning line turns off the first switch and the second switch, the second scanning line inputs scanning signal to turn on the third switch, so that the second pixel electrode is electrically connected with the third pixel electrode, the third pixel electrode receives the data signal from the second pixel electrode to be under the state of displaying the image corresponding to the 2D picture, so that the voltage of the second pixel electrode after first change is changed secondly through the third pixel electrode, the third switch controls the voltage difference between the second pixel electrode and the third pixel electrode not to be zero during turning-on time, wherein, when scanning the first scanning line corresponding to a row of pixel unit, scan the second scanning line corresponding to the previous row of pixel unit which is scanned lately adjacent to the row of pixel unit;
wherein, in the 3D display mode, the second scanning line turns off the third switch, the first scanning line inputs scanning signal to turn on the first switch and the second switch, the first pixel electrode and the second pixel electrode receive the data signal from the data line to be under the state of displaying the image corresponding to the 3D picture, the control circuit affects the second pixel electrode to change the voltage of the second pixel electrode, the third pixel electrode is under the state of displaying the image corresponding to the dark picture when the third switch is turned off.

2. The array substrate as claimed in claim 1, wherein the fourth switch is a thin film transistor, the control terminal of the fourth switch is correspondingly the gate of the thin film transistor, the first end of the fourth switch is correspondingly the source of the thin film transistor, the second end of the fourth switch is correspondingly the drain of the thin film transistor, the width to length ratio of the thin film transistor is smaller than a first setting value, so that the voltage difference between the second pixel electrode and the common electrode not to be zero during turning-on time.

3. The array substrate as claimed in claim 1, wherein the array substrate further comprises a switch unit and a short circuit line located at the peripheral region of the array substrate;
the switch unit comprises multiple controlled switches, the controlled switch comprises a control terminal, an input terminal and an output terminal, the input terminal of each controlled switch is connected with the first scanning line corresponding to a row of pixel unit, the output terminal is connected with the second scanning line corresponding to the previous row of pixel unit adjacent to the row of pixel unit, the control terminals of all the controlled switches are connected with the short circuit line;
in the 2D display mode, the short circuit line inputs control signal to turn on all the controlled switches, when the first scanning line corresponding to the row of pixel unit inputs scanning signal, the scanning signal is input to the second scanning line connected with the output terminal of the controlled switch through the controlled switch at the same time, which turns on the third switch, in the 3D display mode, the short circuit line inputs control signal to turn off the controlled switch and the third switch.

4. The array substrate as claimed in claim 1, wherein the area of the third pixel electrode is smaller than that of the first pixel electrode and the second pixel electrode.

5. The array substrate as claimed in claim 1, wherein the third switch is a thin film transistor, the gate of the thin film transistor is connected with the second scanning line, the source of the thin film transistor is connected with the second pixel electrode, the drain of the thin film transistor is connected with the third pixel electrode, the width to length ratio of the thin film transistor is smaller than a second setting value, so that the voltage difference between the second pixel electrode and the third pixel electrode not to be zero during turning-on time.

6. An array substrate, comprising multiple first scanning lines, multiple second scanning lines, multiple data lines, multiple pixel units and a common electrode used to input common voltage, each pixel unit corresponding to one first scanning line, one second scanning line and one data line;
wherein, each pixel unit comprises a first pixel electrode, a second pixel electrode, a third pixel electrode, a first switch, a second switch and a third switch, each pixel unit further comprises a control circuit, the first pixel electrode is connected with the first scanning line and the data line corresponding to the pixel unit through the first switch, the second pixel electrode is connected with the first scanning line and the data line corresponding to the pixel unit through the second switch, the third pixel electrode is connected with the second pixel electrode and the second scanning line corresponding to the pixel unit through the third switch, the control circuit is connected with the first scanning line and the second pixel electrode corresponding to the pixel unit, the control circuit affects the second pixel electrode to change the voltage of the second pixel electrode when the first scanning line inputs scanning signal, which controls the voltage difference between the second pixel electrode and the common electrode not to be zero;
wherein, in the 2D display mode, the first scanning line inputs scanning signal to turn on the first switch and the second switch, the first pixel electrode and the second pixel electrode receive the data signal from the data line to be under the state of displaying the image corresponding to the 2D picture, the control circuit affects the second pixel electrode, so that the voltage of the second pixel electrode is changed firstly, and then the first scanning line turns off the first switch and the second switch, the second scanning line inputs scanning signal to turn on the third switch, so that the second pixel electrode is electrically connected with the third pixel electrode, the third pixel electrode receives the data signal from the second pixel electrode to be under the state of displaying the image corresponding to the 2D picture, so that the voltage of the second pixel electrode after first change is changed secondly through the third pixel electrode, the third switch controls the voltage difference between the second pixel electrode and the third pixel electrode not to be zero during turning-on time;
wherein, in the 3D display mode, the second scanning line turns off the third switch, the first scanning line inputs scanning signal to turn on the first switch and the second switch, the first pixel electrode and the second pixel electrode receive the data signal from the data line to be under the state of displaying the image corresponding to the 3D picture, the control circuit affects the second pixel electrode to change the voltage of the second pixel electrode, the third pixel electrode is under the state of displaying the image corresponding to the dark picture when the third switch is turned off.

7. The array substrate as claimed in claim 6, wherein the control circuit is a fourth switch, the fourth switch comprises a control terminal, a first end and a second end, the control terminal of the fourth switch is connected with the first scanning line corresponding to the pixel unit, the first end of the fourth switch is connected with the second pixel electrode corresponding to the pixel unit, the second end of the fourth switch is connected with the common electrode, the fourth switch is turned on when the first scanning line inputs scanning signal, so that the second pixel electrode is electrically connected with the common electrode, and the voltage of the second pixel electrode is changed firstly, the fourth switch controls the voltage difference between the second pixel electrode and the common electrode not to be zero during turning-on time.

8. The array substrate as claimed in claim 7, wherein the fourth switch is a thin film transistor, the control terminal of the fourth switch is correspondingly the gate of the thin film transistor, the first end of the fourth switch is correspondingly the source of the thin film transistor, the second end of the fourth switch is correspondingly the drain of the thin film transistor, the width to length ratio of the thin film transistor is smaller than a first setting value, so that the voltage difference between the second pixel electrode and the common electrode not to be zero during turning-on time.

9. The array substrate as claimed in claim 6, wherein the multiple pixel units are arranged in rows, the multiple first scanning lines and the multiple second scanning lines are also arranged in rows; in the 2D display mode, when scanning the first scanning line corresponding to a row of pixel unit, scan the second scanning line corresponding to the previous row of pixel unit which is scanned lately adjacent to the row of pixel unit.

10. The array substrate as claimed in claim 9, wherein the array substrate further comprises a switch unit and a short circuit line located at the peripheral region of the array substrate;
the switch unit comprises multiple controlled switches, the controlled switch comprises a control terminal, an input terminal and an output terminal, the input terminal of each controlled switch is connected with the first scanning line corresponding to a row of pixel unit, the output terminal is connected with the second scanning line corresponding to the previous row of pixel unit adjacent to the row of pixel unit, the control terminals of all the controlled switches are connected with the short circuit line;
in the 2D display mode, the short circuit line inputs control signal to turn on all the controlled switches, when the first scanning line corresponding to the row of pixel unit inputs scanning signal, the scanning signal is input to the second scanning line connected with the output terminal of the controlled switch through the controlled switch at the same time, which turns on the third switch; in the 3D display mode, the short circuit line inputs control signal to turn off the controlled switch and the third switch.

11. The array substrate as claimed in claim 6, wherein the area of the third pixel electrode is smaller than that of the first pixel electrode and the second pixel electrode.

12. The array substrate as claimed in claim 6, wherein the third switch is a thin film transistor, the gate of the thin film transistor is connected with the second scanning line, the source of the thin film transistor is connected with the second pixel electrode, the drain of the thin film transistor is connected with the third pixel electrode, the width to length ratio of the thin film transistor is smaller than a second setting value, so that the voltage difference between the second pixel electrode and the third pixel electrode not to be zero during turning-on time.

13. A liquid crystal display panel, comprising an array substrate, a color filter substrate and a liquid crystal layer located between the array substrates;
wherein, the array substrate comprises multiple first scanning lines, multiple second scanning lines, multiple data lines, multiple pixel units and a common electrode used to input common voltage, each pixel unit corresponding to one first scanning line, one second scanning line and one data line;
wherein, each pixel unit comprises a first pixel electrode, a second pixel electrode, a third pixel electrode, a first switch, a second switch and a third switch, each pixel unit further comprises a control circuit, the first pixel electrode is connected with the first scanning line and the data line corresponding to the pixel unit through the first switch, the second pixel electrode is connected with the first scanning line and the data line corresponding to the pixel unit through the second switch, the third pixel electrode is connected with the second pixel electrode and the second scanning line corresponding to the pixel unit through the third switch, the control circuit is connected with the first scanning line and the second pixel electrode corresponding to the pixel unit, the control circuit affects the second pixel electrode to change the voltage of the second pixel electrode when the first scanning line inputs scanning signal, which controls the voltage difference between the second pixel electrode and the common electrode not to be zero;
wherein, in the 2D display mode, the first scanning line inputs scanning signal to turn on the first switch and the second switch, the first pixel electrode and the second pixel electrode receive the data signal from the data line to be under the state of displaying the image corresponding to the 2D picture, the control circuit affects the second pixel electrode, so that the voltage of the second pixel electrode is changed firstly, and then the first scanning line turns off the first switch and the second switch, the second scanning line inputs scanning signal to turn on the third switch, so that the second pixel electrode is electrically connected with the third pixel electrode, the third pixel electrode receives the data signal from the second pixel electrode to be under the state of displaying the image corresponding to the 2D picture, so that the voltage of the second pixel electrode after first change is changed secondly through the third pixel electrode, the third switch controls the voltage difference between the second pixel electrode and the third pixel electrode not to be zero during turning-on time;
wherein, in the 3D display mode, the second scanning line turns off the third switch, the first scanning line inputs scanning signal to turn on the first switch and the second switch, the first pixel electrode and the second pixel electrode receive the data signal from the data line to be under the state of displaying the image corresponding to the 3D picture, the control circuit affects the second pixel electrode to change the voltage of the second pixel electrode, the third pixel electrode is under the state of displaying the image corresponding to the dark picture when the third switch is turned off.

14. The liquid crystal display panel as claimed in claim 13, wherein the control circuit is a fourth switch, the fourth switch comprises a control terminal, a first end and a second end, the control terminal of the fourth switch is connected with the first scanning line corresponding to the pixel unit, the first end of the fourth switch is connected with the second pixel electrode corresponding to the pixel unit, the second end of the fourth switch is connected with the common electrode, the fourth switch is turned on when the first scanning line inputs scanning signal, so that the second pixel electrode is electrically connected with the common electrode, and the voltage of the second pixel electrode is changed firstly, the fourth switch controls the voltage difference between the second pixel electrode and the common electrode not to be zero during turning-on time.

15. The liquid crystal display panel as claimed in claim 14, wherein the fourth switch is a thin film transistor, the control terminal of the fourth switch is correspondingly the gate of the thin film transistor, the first end of the fourth switch is correspondingly the source of the thin film transistor, the second end of the fourth switch is correspondingly the drain of the thin film transistor, the width to length ratio of the thin film transistor is smaller than a first setting value, so that the voltage difference between the second pixel electrode and the common electrode not to be zero during turning-on time.

16. The liquid crystal display panel as claimed in claim 13, wherein the multiple pixel units are arranged in rows, the multiple first scanning lines and the multiple second scanning lines are also arranged in rows; in the 2D display mode, when scanning the first scanning line corresponding to a row of pixel unit, scan the second scanning line corresponding to the previous row of pixel unit which is scanned lately adjacent to the row of pixel unit.

17. The liquid crystal display panel as claimed in claim 16, wherein the array substrate further comprises a switch unit and a short circuit line located at the peripheral region of the array substrate;
the switch unit comprises multiple controlled switches, the controlled switch comprises a control terminal, an input terminal and an output terminal, the input terminal of each controlled switch is connected with the first scanning line corresponding to a row of pixel unit, the output terminal is connected with the second scanning line corresponding to the previous row of pixel unit adjacent to the row of pixel unit, the control terminals of all the controlled switches are connected with the short circuit line;
in the 2D display mode, the short circuit line inputs control signal to turn on all the controlled switches, when the first scanning line corresponding to the row of pixel unit inputs scanning signal, the scanning signal is input to the second scanning line connected with the output terminal of the controlled switch through the controlled switch at the same time, which turns on the third switch; in the 3D display mode, the short circuit line inputs control signal to turn off the controlled switch and the third switch.

18. The liquid crystal display panel as claimed in claim 13, wherein the area of the third pixel electrode is smaller than that of the first pixel electrode and the second pixel electrode.

19. The liquid crystal display panel as claimed in claim 13, wherein the third switch is a thin film transistor, the gate of the thin film transistor is connected with the second scanning line, the source of the thin film transistor is connected with the second pixel electrode, the drain of the thin film transistor is connected with the third pixel electrode, the width to length ratio of the thin film transistor is smaller than a second setting value, so that the voltage difference between the second pixel electrode and the third pixel electrode not to be zero during turning-on time.
